(19) United States
(12) Patent Application Publication
(10) Pub. No.: US 2009/0302580 A1
(43) Pub. Date: Dec. 10, 2009

(54) AIRBAG DEPLOYMENT SYSTEM

(75) Inventors: Byung Soo KANG, Yongin-si (KR); Seong Hoon LEE, Seoul (KR); Myoung Hun KEUM, Seongnam-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Gyeonggi-do (KR)

(21) Appl. No.: 12/400,979

(22) Filed: Mar. 10, 2009

(30) Foreign Application Priority Data
Jun. 4, 2008 (KR) 10-2008-052689

(51) Int. Cl. B60R 21/16

(52) U.S. Cl. 280/728.1; 701/45

(57) ABSTRACT

An airbag deployment system is disclosed. The airbag deployment system comprises: a sensor module disposed at a passenger seat, for sensing the weight of an occupant in the form of an analog signal and converting the same into a digital signal to output the digital signal; and an airbag control unit for controlling the deployment of an airbag by analyzing the digital signal outputted from the sensor module and comparing the same with a preset value. Accordingly, the manufacturing cost of the product can be reduced, and the reliability of the product can be improved.

### BACKGROUND OF THE INVENTION

1. Field of the Invention

The present invention relates to an airbag deployment system, and more particularly, to an airbag deployment system which can reduce the cost of the product and improve the reliability of the product by eliminating unnecessary components and converting an analog signal into a digital signal, which is more stable, in determining whether an airbag is deployed or not.

2. Discussion of the Related Art

An airbag deployment system is an apparatus for protecting a passenger in a vehicle by absorbing a physical shock generated upon a vehicle collision by using the elasticity of an airbag cushion. Such airbag deployment systems may be classified into a driver seat airbag deployment system, an assistant driver seat airbag deployment system, a side airbag deployment system, and so on.

However, the airbag cushion deployed when gas is introduced into the airbag cushion upon a vehicle collision has a high velocity for passenger protection, and hence if the passenger is an infant or a person having a small build, they may be injured by a shock caused by the deployment of the airbag cushion. Therefore, the deployment of the airbag cushion should be determined in consideration of the weight of a passenger. In this regard, North America regions have regulations on the standards for restricting the deployment of an airbag cushion in accordance with the weight of a passenger measured in a passenger seat under various conditions. Hence, an airbag deployment system designer has to prepare a means for satisfying these conditions for export to the North American market in order to improve the performance of an airbag deployment system.

FIG. 1 is a block diagram schematically showing an airbag deployment system according to the prior art. Referring to FIG. 1, conventionally, the system comprises a weight classification control unit (hereinafter, referred to as “WCU”) which senses the load of an occupant in accordance with a seated state of the occupant by having a plurality of (strain gage) sensors installed at a passenger seat (not shown), amplifying a load value represented as an analog signal and measured by each sensor by an amplifier, and then determining whether the occupant seated on the passenger seat is an infant, a child, or an adult by comparison with a preset value and outputting a corresponding predetermined signal to an airbag control unit (hereinafter, referred to as “ACU”). The ACU deploys the airbag cushion so as to provide a proper deployment force according to the type of an occupant seated on a passenger seat based on a signal outputted from the WCU in the event of a vehicle collision, thereby minimizing the injury of the passenger.

However, the airbag deployment system according to the prior art outputs the load of a passenger sensed by the sensors in the form of an analog signal to the WCU, thus degrading stability compared to a digital signal. That is, the analog signal is amplified to a predetermined amplitude by the amplifier prior to being outputted to the WCU. As the analog signal thus-amplified by the amplifier passes through a wire for conducting the amplifier and the WCU, noise is generated, and thus a voltage drop is accompanied. This leads of the problem of losing the original purpose of the WCU to ensure the safety of an occupant by occupant classification.

In addition, the wire for conducting the amplifier and the WCU necessarily has to output the analog signal itself to the WCU, and thus three types of wires, including a 0-5V analog wire for communicating analog signals of typically 0 to 5V, a power wire, and a ground wire, are basically required, thus increasing the basic cost of the product.

Further, the WCU is necessarily required for occupant classification, and this leads to an increase in the cost of the product.

### SUMMARY OF THE INVENTION

The present invention has been made in an effort to solve the aforementioned problems, and it is an object of the present invention to provide an airbag deployment system which can reduce the cost of the product and improve the stability of the product by allowing an airbag control unit (ACU) to directly receive a digital signal from a sensor module and classify occupants and determine the deployment of an airbag based on the received digital signal.

To achieve the above object, there is provided an airbag deployment system according to the present invention, comprising: a sensor module disposed at a passenger seat, for sensing a weight of an occupant a form of the analog signal and converting the same into a digital signal to output the digital signal; and an airbag control unit for controlling deployment of an airbag and by analyzing the digital signal outputted from the sensor module and comparing the same with a preset value.

The sensor module may comprise: a plurality of sensors disposed at the passenger seat, for sensing the weight of the occupant and outputting the analog signal; and a converter/transmitter for converting the analog signal outputted from the sensors into the digital signal and outputting the digital signal.

The airbag control unit may comprise a digital receiver for receiving the digital signal outputted from the converter/transmitter.

The sensor module may further comprise an amplifier for amplifying the analog signal.

The sensors may be disposed at two positions of the passenger seat, spaced apart from each other.

The sensors may be disposed at four corners of the passenger seat.

The airbag deployment system according to the present invention can reduce the manufacturing cost of the product and greatly improve the stability of the product by eliminating a weight classification control unit (WCU) for classifying a passenger based on the load of an occupant sensed by sensors and outputting an electrical signal to an airbag control unit (ACU).

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram schematically showing an airbag deployment system according to the prior art; and

FIG. 2 is a block diagram showing the overall construction of an airbag deployment system according to the present invention.

### DETAILED DESCRIPTION OF THE PREFERRED EMBODIMENTS

Hereinafter, one exemplary embodiment of an airbag deployment system according, to the present invention will be described in detail with reference to the accompanying drawings.

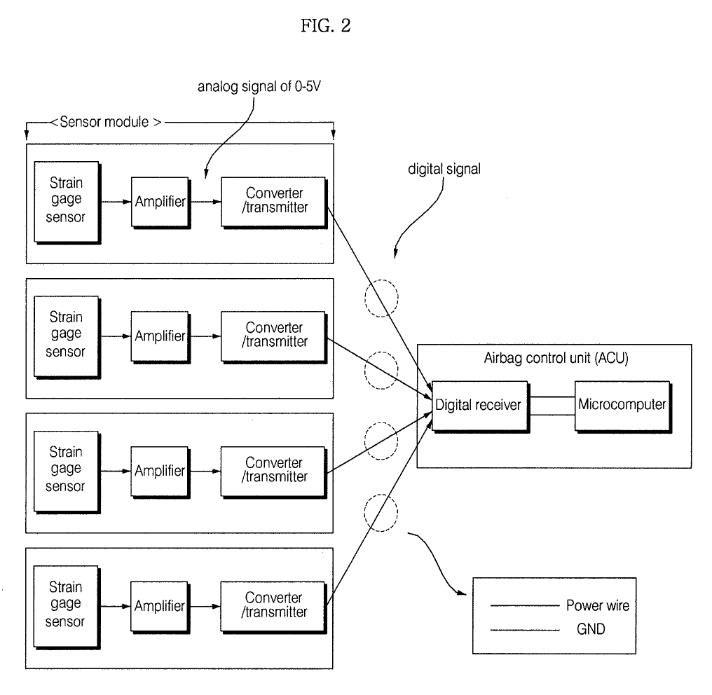

FIG. 2 is a block diagram showing the overall construction of an airbag deployment system according to the present invention. Referring to FIGS. 2 and 3, the airbag deployment system according to the present invention comprises a sensor module for converting an analog signal generated by sensing the weight of an occupant into a digital signal and outputting the same and an airbag control unit for controlling the deployment or an airbag by analyzing the digital signal outputted from the sensor module and comparing the same with a preset value.

In general, as referred in FIG. 2, the sensor module is disposed at a passenger seat where an occupant is seated inside a vehicle. More specifically, the sensor module comprises a plurality of sensors disposed at a lower portion of the passenger seat, for outputting an analog signal by sensing the weight (load) of the occupant and a converter/transmitter for converting the analog signal sensed and outputted from the sensors into a digital signal and outputting it.

Although the converter/transmitter may be comprised of a component divided into a converter for converting the analog signal into a digital signal and a digital transmitter for outputting the digital signal converted by the converter, the exemplary embodiment of the present invention may comprise one component for converting the analog signal into a digital signal and outputting the converted digital signal.

The plurality of sensors may be four sensors respectively disposed at four corners of the lower portion of the passenger seat, or may be two or three sensors respectively disposed at two or three positions on one and the other sides of the lower portion of the passenger seat.

The classification of occupants performed as described above by using the sensors for sensing the load of an occupant may accompany a certain error. Since the classification of occupants is the most important part in the airbag deployment system, it is preferred to adjust a classification margin to be large enough so that occupant classification can be correctly done near a preset value. Especially, the standards for the North American regulations are very strict, and thus the classification margin needs to be considerably large. To maintain a proper classification margin, it is natural that the plurality of sensors are disposed at proper positions of the passenger seat. Hence, it is most preferred that four sensors are disposed respectively at the corners of the passenger seat. However, the respective sensors (or the sensor module) require conduction by the airbag control unit (hereinafter, referred to as “ACU”) and the wire harnesses, and thus an increase in the number of sensors involves an increase in the number of wire harnesses, resulting in an increase in the cost of the product. Therefore, the less the number of sensors, the more advantageous in terms of cost.

The plurality of sensors may be strain gage sensors which display a pressure from the weight of an occupant as a voltage when the occupant is seated. That is, the strain gage sensors sense the load of an occupant and outputs the result value in the form of an analog signal. As generally well known, among the forms of signals, an analog signal has the advantage of reflecting an actual measured result value, but it reflects even noise caused by a change of the voltage. Thus, it is obvious that the analog signal is not suitable for the ACU which wants to correctly classify the type of an occupant to control the deployment of the airbag cushion. Especially, the voltage is varied with the length of the wire harnesses, that is, a so-called noise occurs, so there is a disadvantage of reduction in stability in terms of control as compared to the digital signal.

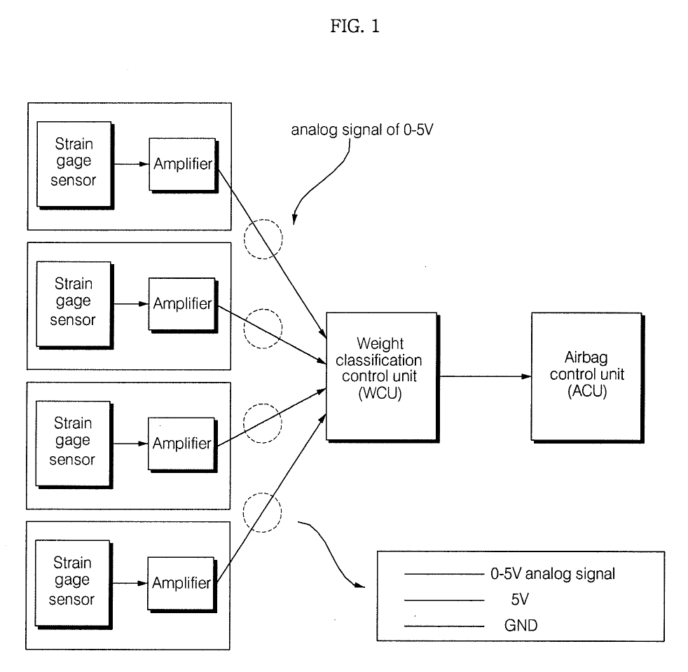

On the other hand, conventionally, the sensor module senses the load of an occupant to output an analog signal, and the weight classification control unit (hereinafter, referred to as “WCU”) receives the outputted analog signal, classifies whether the seated occupant is an infant, a child, or an adult, and outputs a predetermined signal according to the result of classification. Then, the ACU receives it, converts it into a digital signal, and compares the converted digital signal with a preset value to control the deployment of the airbag cushion (see FIG. 1). During this process, the aforementioned noise may occur, and thus stability cannot be ensured in terms of control. In addition, the WCU is necessarily required in order to classify an occupant, thus causing an increase in the manufacturing cost of the product.

Hereto, the present invention proposes this exemplary embodiment by which stability in terms of control is ensured and the manufacturing cost of the product is dramatically reduced on the basis of the above-stated prior art problems. As in one exemplary embodiment of the present invention, the sensor module a converter/transmitter for converting the analog signal into the digital signal and directly outputting the converted signal not to the WCU but to the ACU. In this manner, the advantage of ensuring stability in terms of control can be obtained by converting the load value of an occupant sensed by the sensor module into a digital signal and outputting it by using the converter/transmitter. Further, the cost of the converter/transmitter is fairly low compared to the cost of the WCU. That is, since the converter/transmitter does not need to have a microcomputer unlike the WCU, the manufacturing cost of the product can be significantly reduced. Moreover, the effect of cost reduction is great because of the elimination of wire harnesses, which are the prior art components for conducting the WCU and the sensor module.

The digital signal outputted from the converter/transmitter of the sensor module is transmitted to the ACU by using any one of Manchester communication and DSI communication. A signal transmission method, such as the Manchester communication and the DSI communication, can be simplified by employing the same transmission method as a conventional method of transmitting, to the ACU, a signal outputted from a shock sensor (not shown) disposed on the front face or side face of a vehicle.

The ACU has a digital receiver for receiving the digital signal outputted from the converter/transmitter. The digital receiver may be a multi-type digital receiver which receives a signal outputted from the shock sensor and a signal outputted from a pedestrian sensor for sensing a walking state of a pedestrian for pedestrian protection as well as receiving the digital signal outputted from the sensor module.

Meanwhile, the ACU may have a control logic for determining the deployment of the airbag cushion by classifying the type of a seated occupant by comparing the digital signal received from the sensor module with a preset value in addition to a control logic for determining the deployment of the airbag cushion by identifying a digital signal outputted from the conventionally provided shock sensor. The addition of such a control logic involves the mere addition of a program to existing software, and thus is enabled without hardware replacement.

An operating procedure of one exemplary embodiment of the thus-constructed airbag deployment system according to the present invention will be described below.

First, when an occupant is seated on the passenger seat, the sensors output an analog signal obtained by converting the load pressure in the form of a voltage.

Next, the analog signal is amplified by the amplifier, and then converted into a digital signal by the converter/transmitter, and the thusly-converted digital signal is outputted to the ACU.

During this process, no WCU is required unlike the prior art, and hence the effect of cost reduction due to the elimination of the WCU is anticipated. Further, there is the advantage of improvement of stability in terms of control because the ACU directly receive the digital signal by using Manchester communication or DSI communication.

Finally, having received the digital signal, the ACU classifies the type of the seated occupant by comparing the received digital signal with a preset value and then controls the deployment of the airbag cushion.

So far, one exemplary embodiment of the airbag deployment system according to the present invention has been described in detail with reference to the accompanying drawings. However, this exemplary embodiment is only illustrative and those skilled in the art will understand that various modifications and other equivalent embodiments are possible therefrom. Therefore, the true technical scope of the present invention should be defined by the appended claims.

What is claimed is:

1. An airbag deployment system, comprising:
a sensor module disposed at a passenger seat, for sensing a weight of an occupant in a form of an analog signal and converting the same into a digital signal to output the digital signal; and
an airbag control unit for controlling deployment of the airbag by analyzing the digital signal outputted from the sensor module and by comparing the same with a preset value.

2. The airbag deployment system of claim 1, wherein the sensor module comprises:
a plurality of sensors disposed at the passenger seat, for sensing the weight of the occupant and outputting the analog signal; and
a converter/transmitter for converting the analog signal outputted from the sensors into the digital signal and outputting the digital signal.

3. The airbag deployment system of claim 2, wherein the digital signal outputted from the converter/transmitter of the sensor module is transmitted to the ACU by using any one of Manchester communication and DSI communication

4. The airbag deployment system of claim 2, wherein the airbag control unit comprises a digital receiver for receiving the digital signal outputted from the converter/transmitter.

5. The airbag deployment system of claim 4, wherein the digital receiver is a multi-type digital receiver which receives a signal outputted from a shock sensor and a signal outputted from a pedestrian sensor for sensing a walking state of a pedestrian for pedestrian protection as well as receiving the digital signal outputted from the sensor module.

6. The airbag deployment system of claim 2, wherein the sensor module further comprises an amplifier for amplifying the analog signal.

7. The airbag deployment system of claim 2, wherein the sensors are disposed at two positions of the passenger seat, spaced apart from each other.

8. The airbag deployment system of claim 2, wherein the sensors are disposed at four corners of the passenger seat.
